(19) United States
(12) Patent Application Publication
(10) Pub. No.: US 2006/0218041 A1
(43) Pub. Date: Sep. 28, 2006

(54) Method of rapidly informing a passerby about a food-and-beverage establishment

(76) Inventor: Serguei N. Mamedrzaev, New York, NY (US)

Correspondence Address: BRUZGA & ASSOCIATES, 11 BROADWAY, SUITE 715, NEW YORK, NY, 10004, US

(21) Appl. No.: 11/104,813

(22) Filed: Apr. 13, 2005

Related U.S. Application Data
(60) Provisional application No. 60/659,313, filed on Mar. 7, 2005.

(51) Int. Cl. G06Q 30/00

(52) U.S. Cl. 705/15

(57) ABSTRACT

Method of rapidly informing a passerby outside a food-and-beverage establishment about the establishment, so as to entice the passerby to use the services of the establishment, comprises placing an interactive electronic menu board in a location accessible by a passerby from outside the establishment. The interactive menu board broadcasts, by graphical/textual/audio content, aspects of the establishment, and has user-activated links enabling the passerby to expand on a desired category of information, and thereby rapidly informs the passerby. The menu board screen provides a passerby with an information-gathering but non-purchasing relationship with the establishment so the passerby can become informed about the establishment in a non-committal manner. The primary purpose of the menu board is to promote the services of a single establishment. A preferred form of the method's default mode comprises attracting the attention of the passerby by dynamically broadcasting text, graphics or audio sounds.

This application claims priority from U.S. Provisional Patent Application No. 60/659313 filed on Mar. 7, 2005.

### FIELD OF THE INVENTION

The present invention relates to a method of rapidly informing a passerby about a food-and-beverage establishment, so as to entice the passerby to use the services of the establishment. A preferred aspect of the invention comprises attracting the attention of a passerby outside the establishment with a default mode of dynamically broadcasting text, graphics or sounds.

### BACKGROUND OF THE INVENTION

### Traditional Approach

Food-and-beverage establishments, such as restaurants, cafes, bistros, lounges, etc., traditionally publicize their different menus, specials of the day, special events, promotions and many other types of information and signs typically by posting them outside of the establishment so as to be visible to the passersby. All the establishment menus, promotions and other signs are generally in hardcopy form, sometimes printed or typed and sometimes handwritten. The menus, promotions and most of the other signs serve to entice the passersby to use the services of the establishment. Such “services” not only include offering food and beverage, but also include providing an attractive atmosphere for dining, as well as organizing special events such as musical performances, wine tastings, karaoke, etc.

As used herein, “passersby” are potential customers of an establishment, which include persons who have not previously used the services of the establishment as well as persons who have previously used such services.

Often, in order to better promote its services, a food-and-beverage establishment has no choice but to post more and more menus or other promotions from outside of the establishment so as to be visible to the passersby. This method of informing the passersby about a food-and-beverage establishment results in three major drawbacks, including (1) limitation in the amount of information provided, (2) a cluttered look, and (3) difficultly of updating. These drawbacks are discussed as follows.

First, since hardcopy menus, promotions or other signs are in a fixed form, they are limited in the amount of information they can provide. The passersby who are looking for more details regarding a specific aspect of the establishment may feel that the details needed to help them to make a decision, regarding whether or not to enter and use the services of that establishment, are not provided. This inability to expand upon what is provided by hardcopy menus may result in turning away passersby from using the services of that establishment.

Second, a passerby viewing the exterior of a food-and-beverage establishment will often be influenced on whether the use the services of the establishment based on the exterior appearance of that establishment. With many menus and other signs posted on the exterior of the establishment, aside from being confronted with a cluttered look, a passerby will often have difficultly finding desired information, and may be dissuaded from using the services of the establishment.

Third, it is a constant challenge for the owner or manager of a food-and-beverage establishment to keep all menus and signs current. Menus, for instance, typically require considerable and time-consuming steps to update, such as marking up a menu, traveling to a printer to revise and print the menu, opening a framed menu board to replace the old one, re-writing (by hand) an entire menu board and so forth. Frequent and repeated hardcopy menu updates, which often occur on a daily basis, are impractical and inefficient.

### Inventive Method

In view of the abovementioned drawbacks of the traditional method of displaying hardcopy menus, promotions, etc., to passersby of a food-and-beverage establishment, it would be desirable to use a new method that eliminates the abovementioned drawbacks.

In one form, the method concerns placing an easy-to-update, interactive electronic menu board in a location accessible by a passerby consumer from outside the food-and-beverage establishment. The interactive menu board shows, by graphical and textual content, aspects of the food-and-beverage establishment, and has user-activated links that enable the passerby to expand on a desired category of information about the different aspects, and thereby rapidly informs the passerby about the food-and-beverage establishment. A preferred form of the present method's default mode comprises attracting the attention of the passerby by dynamically broadcasting text or graphics on a menu board or in some cases, audio sounds from audio speakers.

### Directory Kiosks

The present, inventive method differs from the use of existing, interactive directory kiosks employed by a considerable number of businesses, such as those located in large buildings or airports. Directory kiosks typically provide a limited amount of information about each business, as their primary purpose is usually to show the location and category of the many businesses.

In contrast, the primary purpose of the menu board of the present method is to promote the services of a single food-and-beverage establishment by providing in-depth and focused information about this establishment to entice a passerby to use its services. The menu board of the present method replaces and enhances any traditional hardcopy menu form visible from outside of an establishment, a feature expected by patrons outside of any food-and-beverage establishment. Accordingly, it will usually be placed in the immediate vicinity of the establishment, or it may be placed near an access location to the establishment (e.g., near a street level entrance for a second-floor restaurant).

### Self-Ordering Display Systems

The present method also differs from the use of existing self-ordering display systems located and accessible from inside a food-and-beverage establishment. Being located and accessible from inside such an establishment, a potential customer who has entered the establishment has already made a form of social commitment to use the services of the establishment. Further, some establishments seek to have customers actually purchase services from a self-ordering display screen located and accessible from inside an establishment. Any financial transaction through this self-ordering display system requires a commitment by the customer to use the services of the establishment.

In contrast, the present method's purpose is to reach potential customers who are passersby outside of an establishment and who have not yet decided to enter the establishment. The method does this by attracting the attention of passersby and easily and rapidly informing them about the services of the establishment. Using an interactive, electronic menu board, accessible from outside of an establishment, allows the establishment to provide a passerby with an information-gathering but non-purchasing relationship with the establishment, so that the passerby can become informed about the establishment in a non-committal manner.

Additionally, the present method targets a different stage of a potential customer's decision-making process than a self-ordering system located inside an establishment. As such, selection and presentation of information features will differ in many respects. For instance, the preferred form of the present invention in its default mode, employs a dynamic presentation of information to a passerby, including, but not limited to, images of the establishment's interior. These images capture the attention of the passerby, who has not yet committed to use the services of this establishment, and help to influence the passerby's decision-making process at the earliest stage. In comparison, presentation of images of the establishment's interior would be unnecessary for a self-ordering display system located and accessible from within an establishment, since the customer would already have entered and seen the interior of the establishment and made the decision to use its services.

### SUMMARY OF THE INVENTION

In accordance with a preferred form of the invention, there is provided a method of rapidly informing a passerby outside of a food-and-beverage establishment about the establishment that serves to entice the passerby to use the services of the food-and-beverage establishment. The method comprises placing an easy-to-update, interactive electronic menu board in a location accessible by a passerby from outside the food-and-beverage establishment. The interactive menu board shows, by graphical and textual content, different aspects of the food-and-beverage establishment, and has user-activated links that enable the passerby to expand on a desired category of information about the aspects, and thereby rapidly informs the passerby about the establishment. The menu board screen provides a passerby with an information-gathering but non-purchasing relationship with the food-and-beverage establishment so that the passerby can become informed about the food-and-beverage establishment in a non-committal manner. The primary purpose of the menu board is to promote the services of a single establishment. A preferred form of the present method's default mode comprises attracting the attention of the passerby by dynamically broadcasting text, graphics or audio sounds.

The foregoing invention eliminates a cluttered look of the prior art use of hardcopy menus and other signs, allows easy updating of information shown, and has user-activated links to allow a passerby to instantly expand on a desired category of information about the food-and-beverage establishment.

Further, implementation of the foregoing invention will not require any changes (i) to the restaurant's environment, (ii) in the procedures used by waiters to place orders (e.g. waiters' point-of-sale ordering systems), and (iii) in its cash-register procedures. Nor will the present invention require installation of multiple touch-screen displays or computer servers, or additional training of staff, etc. It offers the establishment's owner an easy-to-use and cost-effective advertising tool for attracting and informing potential customers, with the ability to easily update information from any available computer.

A potential customer using an interactive electronic menu board according to the present method can also become rapidly informed of specific services that are desired at that moment. For instance, through a preferred form of the present method, a customer will often already know how the food looks, how it is prepared, the caloric and nutritional value, price, etc., even before entering the establishment. Thus, an interactive electronic menu board accessible from outside of the establishment can rapidly facilitate potential customer's decision-making process, not only in helping the customer to decide whether or not to eat in this establishment but also what to eat. Once inside, the customers can promptly order services, saving their time and the establishment's time, and allowing quicker turnover of tables and profitability for the restaurant.

A preferred form of the present invention allows foreigners to obtain all desired information in their own native language. This will be extremely useful in international tourist areas and hotels where menus are traditionally displayed in a single language.

Other features and benefits of the invention will become apparent from reading the following description in connection with the appended drawings.

### DESCRIPTION OF THE DRAWINGS

In the following drawings, like reference numerals refer to like parts.

FIG. 1 compares front views of the outside of a restaurant according to the prior art, and the outside of the same restaurant according to the invention.

FIGS. 2 and 3 are perspective views of an electronic menu board, with FIG. 4 showing a detail of the menu board of FIG. 2.

FIGS. 5-7 are front views of electronic menu board displays used in the present method.

FIG. 8 is similar to FIG. 5, but shows a pop-up dialog on the screen of FIG. 5.

FIG. 9 is a perspective view of a menu board with a call-out indicating a spoken sentence in Japanese.

FIG. 10 contains two boxes showing method steps.

FIG. 11 is a series of five front views of electronic menu board displays used in the present invention.

FIG. 12 is a partial view of a representation of an electronic menu board display.

FIG. 13 is a partial view of a dialog box of software used for uploading information to an electronic menu board display.

### DETAILED DESCRIPTION OF THE INVENTION

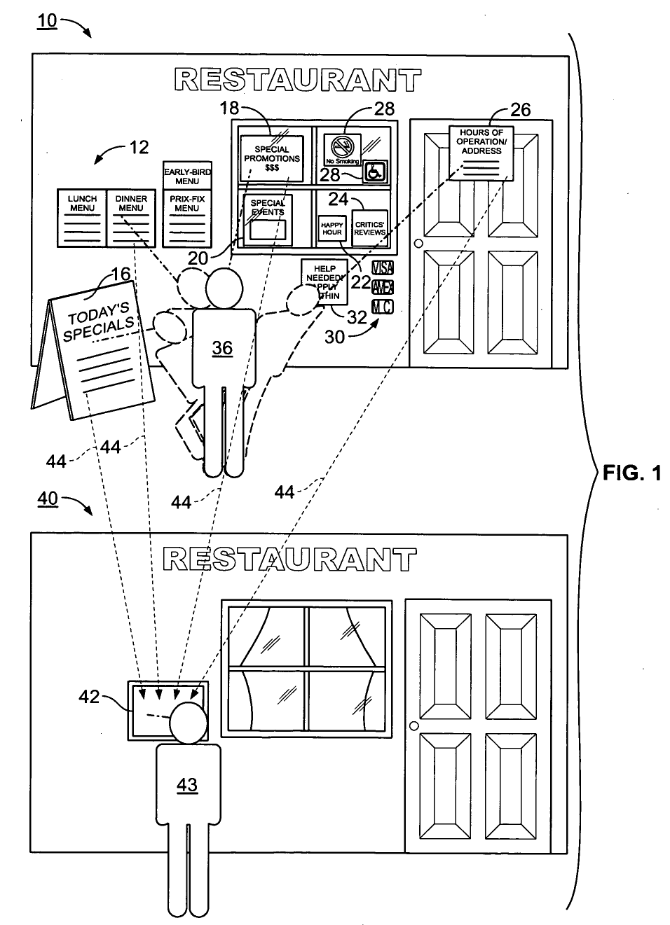

FIG. 1 contrasts a traditional food-and-beverage establishment (i.e., restaurant) 10 with an establishment 40 using an electronic menu board 42 in accordance with the present method. Traditional establishment displays hardcopy menus 12 and many other signs such as: “Today's Specials” 16, “Special Promotions” 18, “Special Events” 20, “Happy Hour” 22, critic's reviews 24, hours of operation 26, wheelchair access and smoking signs 28, accepted credit card signs 30, and Help Wanted or other signs 32.

Thus, a potential customer 36 is often confronted with many signs displayed in a cluttered fashion on the exterior of a traditional establishment 10. Potential customer 36 must often spend several minutes searching for desired information among all the various posted signs. In this process, potential customer 36 may be required to bend, look up and look around in search of a relevant sign. Once a relevant sign is found, the static, hardcopy nature of the sign limits the amount of information provided.

In contrast, the same establishment can replace some or all of the various signs 12-32 with a single electronic menu board 42. All of signs 12-32 can be shown on menu board 42, usually at different times and, importantly, as desired by a potential customer 43, as indicated by dashed-line arrows 44. The customer does not need to bend, look up and around, as with the traditional establishment 10, but can comfortably view all the same information from one location—the electronic menu board 42.

Menu board 42 is interactive, preferably comprising a resistive touch-screen such as those available from (1) Elo TouchSystems, Inc. of Menlo Park, Calif.; (2) Radiant Systems, Inc. of Alpharetta, Ga.; or (3) CyberTouch of Newbury Park, Calif. However, other types of interactive technologies will be apparent to a person of ordinary skill in the art based on the present specification. Interaction can be provided, by way of example, by voice commands from a potential customer, by any scrolling devices (e.g. trackball, joystick) or by sensor-activated touchless communication. Suitable drivers for the menu board may be internal to the menu board, or can be located in a separate computer connected to the menu board. Significantly, if desired, the drivers can be stand-alone drivers in the sense that a current display is not dependent on current Internet signals. On the other hand, it may be desired that updates to the display content can be provided via the Internet or other types of connections, for instance.

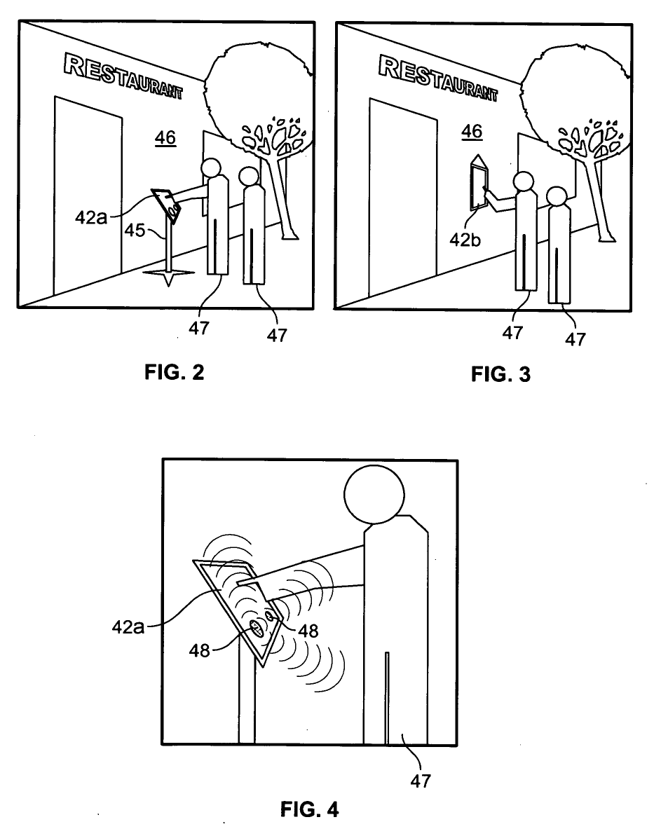

FIG. 2 shows an electronic menu board 42a mounted on a pedestal 45 in front of a restaurant 46. Multiple passersby 47 are observing the menu board, although only the closest passerby is interacting by hand with the menu board. FIG. 3 shows a similar view, but with a menu board 42b mounted on an exterior wall of restaurant 46. FIG. 4 shows a detail of the menu board of FIG. 2 in which sound speakers 48 provide audio information to passerby 47. Menu board 42a may be equipped with a microphone (not shown) for receiving audio commands from the passerby.

Menu boards 42a and 42b of FIGS. 2-4 may have frames, as shown, with the appearance of a traditional menu board for a hardcopy menu. Or, frames may be customized as desired, and be weatherproofed for outdoor use.

As shown in FIGS. 2 and 3, an electronic menu. board 42a or 42b might be located in the immediate outside vicinity of a food-and-beverage establishment. More broadly, an electronic menu board according to the present method may be located wherever there are passersby whom the establishment wishes to attract. Thus, an electronic menu board might be placed at street level for a restaurant located above or below street level. Or, the menu board might be placed at the lobby of a hotel in which the establishment is located, or in the elevators of the hotel, or wherever passersby are located.

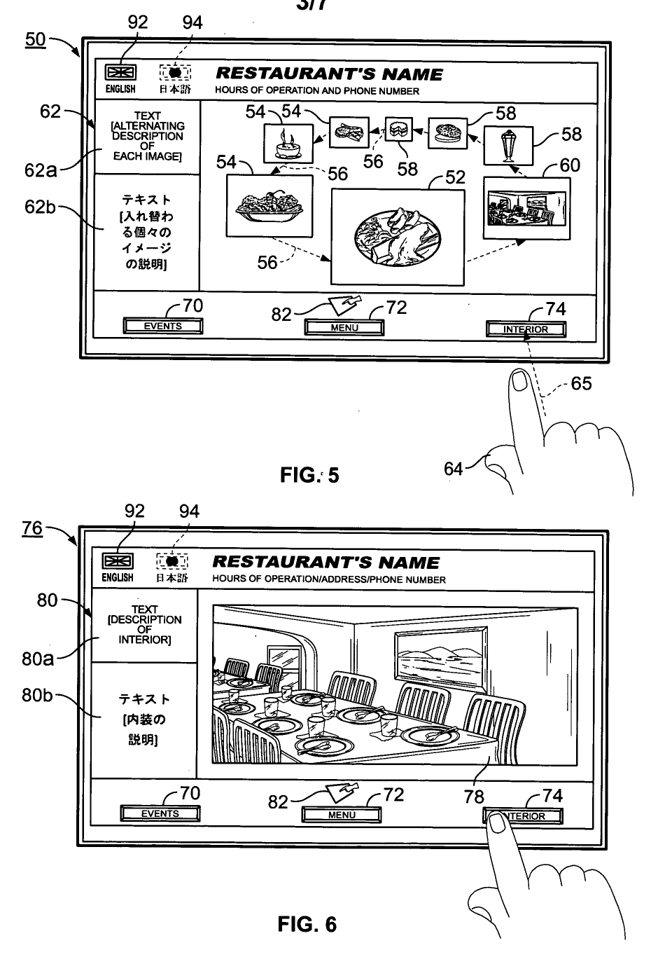

FIG. 5 shows an electronic menu board display 50 with one example of a customized, dynamic visual display of information, comprising a slide show. In the example shown, a main, enlarged slide 52 appears near the center of menu board display 50. Upcoming slides 54, as noted by dashed-line arrows 56, will each, in turn, become the main, enlarged slide. Upcoming slides 54 may be partially (or fully) faded out so as to give the main slide prominence. Upcoming slides 54 may show food items being currently served, and succeeding slides 58 may also show food items being currently served. Or, as shown in slide 60, an interior view of the establishment, for instance, may also be shown. Whatever the establishment wishes to promote can be shown in the dynamic slide show. An alternative to a slide show would be video (i.e., movie) presentations.

Preferably accompanying the slide show is text 62, consisting of a description of each image as it appears as the main slide 52. Since the slide show dynamically changes, text 62 alternates so that it keeps describing the image in the main slide 52. Preferably, text 62 comprises multiple languages, such as English 62a and Japanese 62b. The availability of this multi-lingual feature is quickly made obvious to the potential customers before any interaction with the electronic menu board. The English and Japanese text might appear simultaneously, or sequentially, while an image in the main slide 52 is being portrayed. Alternatively, or in addition to the dynamic slide show, a dynamic presentation of audio sounds, preferably multi-lingual, is provided by the menu board (as by speakers 48 in FIG. 4), to further capture the attention of potential customers passing by.

It is especially beneficial for the dynamic slide show of FIG. 5 to be the default mode of menu board display 50. The same is true of the mentioned dynamic audio presentation. This is to attract the attention of potential customers who are merely passing by a food-and-beverage establishment.

As shown on menu board 50 of FIG. 5, the services of a single food-and-beverage establishment are promoted. More accurately, the primary purpose of the menu board is to promote the services of a single establishment to passersby. This is determined in an objective way by the eye-catching prominence of text or graphics on the menu board.

FIG. 5 also illustrates preferred button icons 70, 72 and 74, for instance, that are shown in every view of the menu board. Button icons 70, 72 and 74 relate to Events, Menu and Interior of a food-and-beverage establishment or to any other aspects of the establishment that the owner wants to promote. If a potential customer wishes to know more about the interior of the establishment, the user's hand 64 can touch Interior button icon 74 (in the case of a touch screen type of menu board). This hand motion is indicated by arrow 65. Upon being touched, a menu board display 76 as shown in FIG. 6 is obtained.

FIG. 6 shows an interior view 78 of the establishment, with accompanying text 80. Text 80 is preferably multi-lingual, with upper text 80a in English, and lower text 80b in Japanese, for instance. Symbol 82, shown in some of the present drawings, is a visual icon indicating touch-screen interactive operation, which may be used if the electronic menu board uses touch-screen technology. View 78 of the establishment's interior can be a single slide or video, one of a series of changing slides or videos, of the establishment. If view 78 changes, then text 80 would change in similar fashion as text 62 of FIG. 5, as explained above.

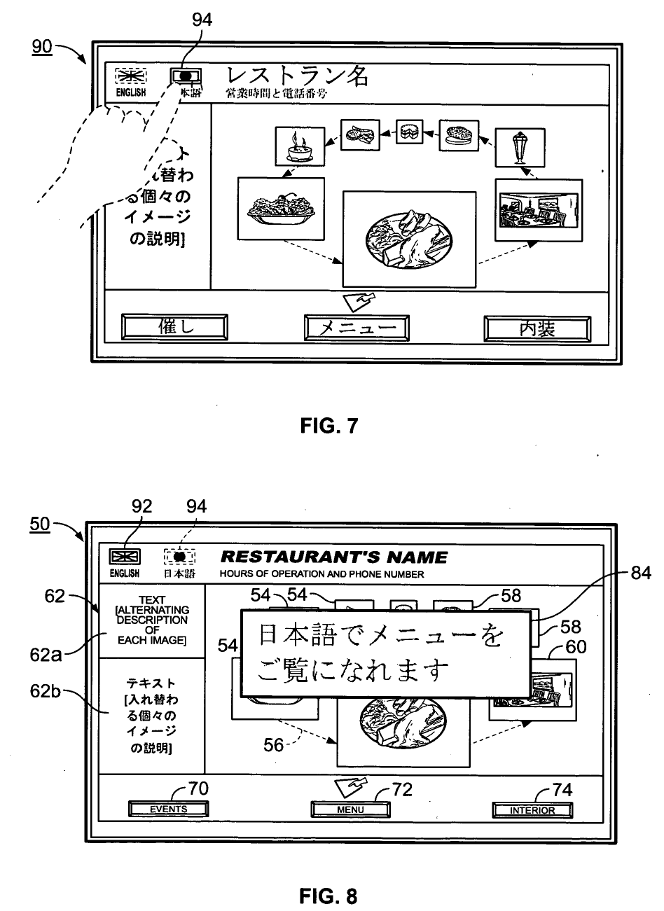

After a potential customer realizes from the menu board displays of FIGS. 5 or 6 that the menu board has multi-lingual capacity, the customer will more likely recognize language icons 92 and 94. Upon selecting icon 94 showing a Japanese flag in FIG. 5, for instance, the display changes to that shown in FIG. 7. in which all language text (except for “English” under the English flag, for instance) appears in Japanese.

Menu board display 90 of FIG. 7 shows the same visual content as menu board display 50 of FIG. 5. However, since the Japanese language icon 94 has been selected, preferably all the text, as shown, appears in Japanese. Preferably, all text shown after the Japanese language icon 94 has been selected will appear in Japanese. This enables a person fluent in Japanese, but not the other language(s) presented, to easily understand the information being presented. After not being used for a certain period of time (e.g., 15 seconds), the menu board display will revert back to a default language. Of course, the information on the menu board display can be made available in more than the two languages illustrated.

Another way of informing a potential customer of the multi-lingual capability of a menu board is to use a pop-up dialog. As shown in FIG. 8, such a pop-up dialog 84 announces, in a language (e.g., Japanese) different from a default language (e.g., English), that such different language can be used. The translation of the Japanese text in pop-up dialog box 84 is “Menu can be viewed in Japanese.” Other graphics or text on the screen may recede from view to emphasize pop-up 84.

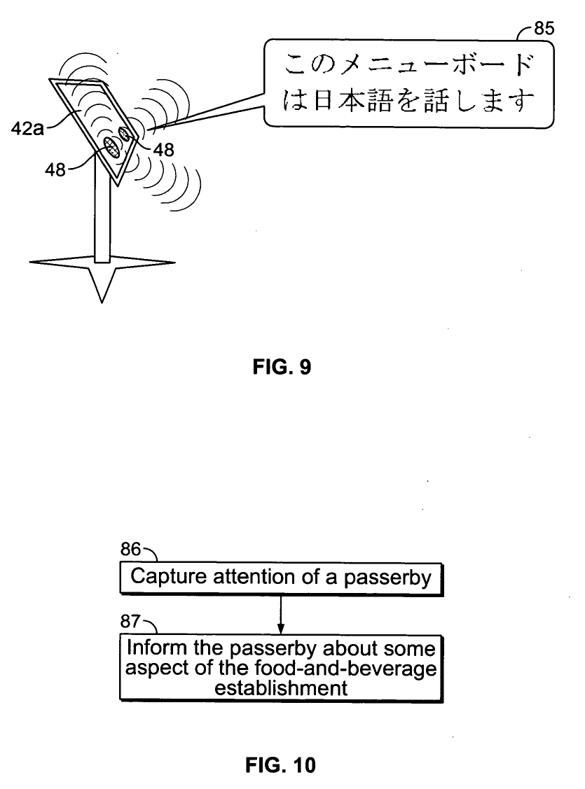

Alternatively, if speakers such as 48 in FIG. 4 accompany the menu board, the speakers can announce that a language (e.g., Japanese) that differs from a default language (e.g., English) can be used. As shown in FIG. 9, for instance, a call-out 85 shows an audio announcement in Japanese that translates into English as, “This menu board speaks Japanese.” The audio announcement comes from speakers 48 on menu board 42a, for instance.

FIG. 10 summarizes a preferred aspect of the present method. FIG. 10 shows a method-step box 86 aimed at capturing the attention of a passerby, followed by a method-step box 87 for informing the passerby about some aspect of the establishment. Capturing the attention of a passerby can be accomplished by the dynamic default display (slide show) shown on menu board 50 of FIG. 5, for instance, by the dynamic pop-up 84 shown on menu board 50 of FIG. 8, or by the dynamic audio announcement 85 shown in FIG. 9. Many variations of dynamically capturing the attention of a passerby will be apparent to persons of ordinary skill in the art based on the present specification. For example, text, graphics or sound can be dynamically broadcast, by flashing (to replace neon signs, for instance), or pop-ups, or by informative written or spoken language such as “We are open now,” or “Serving now,” or “Live Jazz Tonight!.” Alternatively, promotional language could be dynamically broadcast in a quiz form such as “Answer this Question Right, and Get a 10% Discount [or some free services] in our Restaurant.”

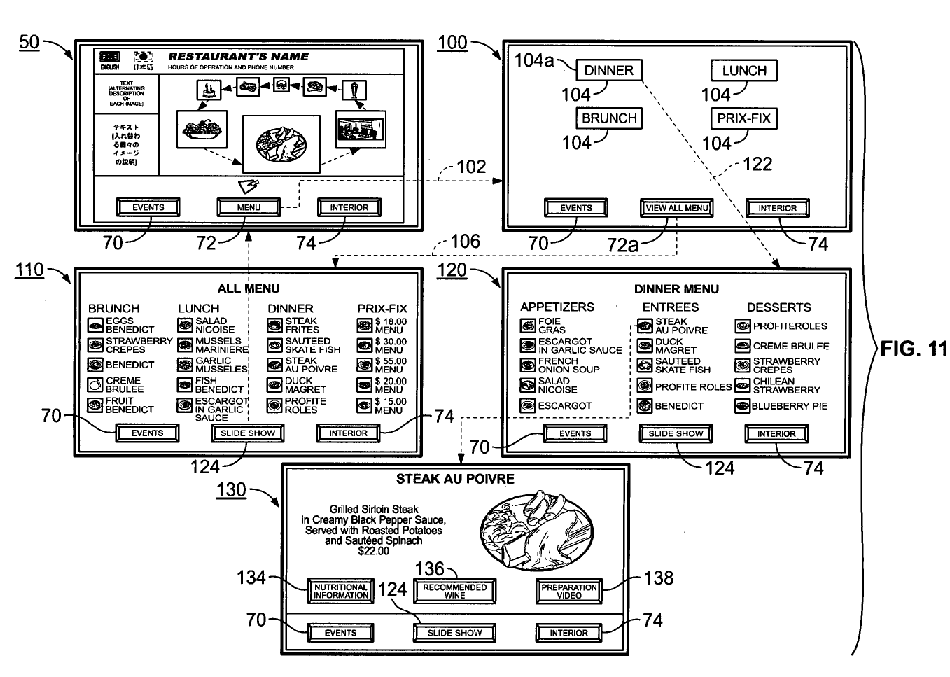

FIG. 11 illustrates a highly preferred feature of the present method, by which a potential customer can see at one glance all or most of the food items served for a particular time of day. Starting from the dynamic menu board display 50, which is also shown in FIG. 5, a potential customer selects Menu button icon 72 to thereby show menu board display 100. This change in menu board display is shown by dashed-line arrow 102.

Menu board display 100 allows the customer to choose to view specific menus (e.g., dinner or lunch), by selecting the corresponding icons 104 or 104a, or to view all menus by selecting the View All Menu button icon 72a. As can be seen from comparing menu board displays 50 and 100, Menu button icon 72 on display 50 changes into View All Menu button icon 72a on display 100. If a customer selects View All Menu button icon 72a on display 100, as shown by arrow 106, a menu board display 110 appears which displays all or most food items.

Menu board display 110 shows thumbnail images of all or most of the food items on the full (or All) menu. Preferably, brief text accompanies each of the thumbnail images, such as shown in display 110, giving the name of the food. The ability for a potential customer to view the images of all or most food items at a single glance powerfully facilitates the decision-making process of the customer in selecting a particular food item for consumption. Showing all or most food items at the same time with 3-dimensional plastic models displayed near an entrance to many restaurants in Japan has served for many years to help potential customers quickly decide whether to order a particular food item. Some restaurants in the United States also have adopted such custom.

While viewing menu board display 100, the potential customer might select Dinner menu button icon 104a (rather than View All Menu button icon 72a) to view menu board display 120, as shown by dashed-line arrow 122. Arrow 122 starts on Dinner menu button icon 104a and ends on display 120. Display 120 shows most or all of the dinner menu items, including, if desired, appetizers and desserts in addition to entrees.

In both menu board displays 110 and 120, the central, lower button icon 124 labeled “Slide Show” permits instant return to display 50 that includes the slide show.

From either of the menu board displays 110 or 120, showing images of food items, a customer can select a food item to view an enlarged image of the desired item and accompanying text description and price. Preferably, as shown in menu board display 130, the customer can select button icons or other icons to view expanded information on the desired item. For instance, the customer can select any of button icons 134, 136 or 138 to see information on nutrition, recommended wine or a preparation video, respectively. As such, the potential customer can quickly make a very informed decision about a food item to order.

In addition to a potential customer becoming rapidly informed about a particular food item, providing an image and detailed description of this item creates certain expectations regarding the quality, quantity, and presentation of this food item. By heightening the customer's expectation of the item based on its presentation and description displayed on the interactive electronic menu board, the food-and-beverage establishment now has a greater incentive to meet those expectations and avoid customer dissatisfaction. This process serves to enhance quality control of food items.

In addition to simultaneously displaying most or all of the food items in a menu as in FIG. 11, the menu board could display multiple items in another category or subcategory of the establishment's services. For instance, most or all of the establishment's cocktails could be simultaneously displayed in thumbnail form, or most or all of the jazz band events could be simultaneously shown in thumbnail form. The same applies to other events of the establishment, or images of the interior of the establishment. Having most or all of the items in a category of services simultaneously displayed facilitates rapid decision-making by a potential customer on selecting which services to use.

By using an electronic menu board in accordance with the present method, many categories of information can be easily presented on a relatively small board. Most information can be provided in an enhanced (e.g., detailed), interactively obtained manner. Secondly, as mentioned above, a menu board can reduce clutter outside a food-and-beverage establishment by eliminating the need for hardcopy signs. Thirdly, courtesy features can be added to the menu board to additionally assist potential customers (e.g., informing them of the current time, current weather update, local area map, etc.).

The following chart and description describe preferred features or signs, some or all of which an establishment may wish to incorporate in a menu board. Of course, an establishment has an option to use any of the following features.

FEATURES

Menu
Events
Interior
Languages
Today's Specials
Bar Selection
Wine List
About Us
Make Reservation
Parties
Promotion (Happy Hour)
Our Chef
Specialty Cocktails
Critics/Press
Area Map
Time and Date
Payment methods
Service and commodity signs
Custom signs
Optional Icons

The “Menu” feature will inform the potential customer about all the food menu offerings. Preferably, this feature will display a list with all menu items, detailed descriptions of those items including the price, and an actual image (photograph) of a desired menu item. Other optional icons will mention a recommended wine(s) to compliment a desired menu item, nutritional facts of the item, or a video demonstration of how the item is prepared.

Beneficially, the Menu feature will answer the most common questions about the establishment's food before customers come inside, such as:
“How big is this dish?”
“What comes with it?”
“What does it look like?”

The “Events” feature will inform the potential customer about any special events hosted by the service-oriented establishment. This feature will allow people to see the schedule of the events, detailed descriptions of those events and the ability to see images (photographs/posters) of the events and, if audio speakers (e.g., 48, FIG. 4) are available, to listen to the music style in case of a live band. Photos and brief descriptions of past events can also be shown. For instance, the Events feature might say, “Live jazz band every Wednesday night,” and display a picture of the band, provide sample sound tracks, and show a schedule of the event.

The “Interior” feature will allow the potential customer to see images (photographs) and detailed description of the inside of the establishment. This can be especially important for some restaurants, for instance, those located on the second floor of a building, where passersby (i.e., potential customers) are outside on a sidewalk, and do not want to make the commitment of going up the stairs and to enter just to see the interior of this restaurant.

The “Languages” feature will offer the potential customer all information in languages different from a default language. This is an important feature for the international hospitality industry. In particular, it is well suited for restaurants in tourist or high-density, multicultural areas, or in international hotel restaurants, such as, for example, a restaurant in a Paris hotel that wants Japanese tourists to be able to read its menu.

The “Today's Specials” feature will inform a potential customer about the restaurant's specials of the day. It will display a list with the day's special items, detailed descriptions of those items including the price, and an actual image (photograph) of a particular day's special item of interest, or a video demonstration of how a particular day's special item of interest is prepared. Some of these features are illustrated in connection with the menus of FIG. 11.

The “Bar Selection” feature will inform potential customers about the establishment's bar selection, including any items that could help attract the target customers. It will allow the establishment to display a list with all bar items, detailed descriptions of those items including the price, an actual image (photograph) of different areas of the bar display. For instance, it can show images of premium vodkas for martini enthusiasts, single malts selection for whiskey lovers, draft beers, etc.

The “Wine List” feature will inform the potential customer about the establishment's full wine selection. It will display a list of all wines, detailed descriptions of them including the price, the serving size (by the glass, by the bottle, by carafe . . . ), and an actual image (photograph) of a particular wine of interest or of the establishment wine cellar. For instance, a person, who wants to eat a steak without any particular preference as to where to eat it, might be better attracted and enticed by a bottle of “St. Emilion” 1998, available in the restaurant's collection and shown on a “Wine List” selection.

The “About Us” feature will provide the potential customer with a description of the venue's philosophy, history and cuisine. By showing the best aspects of its business, an establishment will become more attractive to the potential customer. For instance, the establishment can list or show photos of celebrity visitors, owners, famous historical location, renowned chef, unique cuisine or short video broadcasts of movies/television scenes where the establishment is featured, etc.

The “Make Reservation” feature will offer the potential customer the opportunity to make a reservation (e.g. to enter name, date, time and number in party) and select the table they want to sit at (based on availability). Personal information could be entered through any available interactive means employed by the present method—on-screen keyboard, voice command, integrated hardware keyboard, of projection keyboard, etc. This could be especially useful if an establishment is closed and the customer wants to eat there the following night and wants to be seated by the window to enjoy the view. This data entry and storage capability of the interactive menu board will also allow a potential customer to become a “member” of the establishment by entering his or her e-mail address (or mailing address, or cellular phone number, etc.) and be eligible for regular updates on the establishment's “Specials of the Day”, upcoming events and various promotions.

The “Parties” feature will inform the potential customer of the restaurant's capability to organize and host parties. It will allow people to see images (photographs) of party/table set-ups, a list of party menu samples and a list of all services the establishment could provide to accommodate an event. For instance, it will make it easy to obtain information such as the maximum number of seated people, sample menus, availability of TV screens, karaoke machines, microphones, stage, band, DJ, flowers arrangements, etc.

The “Promotion” feature will inform the potential customer of any type of special offerings, such as a Happy Hour promotion.

The “Our Chef” feature will inform a potential customer about the restaurant's Chef. It will allow the people to see the Chef's picture, biography, awards and culinary creations with display of images (photographs) and preparation video of Chef's specialties. This is an important tool for an establishment having a celebrity Chef.

The “Specialty Cocktails” feature will inform the potential customer of the different cocktail specialties or creations of the establishment. It will display a list with all specialty cocktails, detailed descriptions of those specialty cocktails including the price, and an actual image (photograph) of a particular specialty cocktail of interest, or video demonstration of how that cocktail is prepared. For instance, a lounge specialized in Martinis, showing how they prepare their top-selling cocktail, will likely attract customers looking for fancy cocktails.

The “Critics/Press” feature will inform the potential customer about any reviews of the establishment made by critics in magazines or any other media.

The “Area Map” feature will inform the potential customer (and the many other inquisitive tourists, etc.) about the surrounding area. It will help people to locate another tourist attraction in the neighborhood, for instance, while minimizing the time required of restaurant personnel to explain the surrounding areas. For instance, the Area Map can show museums, parks, theaters etc., in the area. It will be especially helpful for customers of large international hotels who try to locate another attraction provided by the hotel.

The “Time & Date” feature will display the current time and date. It will help the potential customer who makes a reservation to check the date. This also serves as a courtesy feature for passersby.

“Payment Methods” signs will inform the potential customer about the acceptable payment methods, such as credit cards types, discount cards, etc.

“Service” signs (e.g., Smoking/Non-Smoking, Handicapped Access, Parking, Parking Valet Service, Panoramic view, Terrace, Garden, etc.) will inform the potential customer about the establishment services and commodities. For instance, on a beautiful summer day, a potential costumer will be more attracted to a restaurant with a garden or terrace.

“Custom signs” (e.g., Kosher Food, Help Wanted, Closed for Private Party/Construction, Holidays Signs, Multi-Lingual Staff, etc.) will inform the potential customer about anything the establishment operator deems necessary to inform about, in an easy, fast and attractive way and without cluttering the window or door of the restaurant with hardcopy signs.

The following three Optional Signs can be used to provide enhanced, interactively obtained information concerning food items:

(1) A “Preparation video” icon (e.g., 138, FIG. 11) will help to show in a short video demonstration how the particular item is prepared. It will provide better presentation and promotion of this item, and answer potential customers' questions about preparation.

(2) A “Recommended Wine” icon (e.g., 136, FIG. 11) will help enhance the presentation of a food item by telling the potential customer what wine the Chef recommends for a particular dish and why. Descriptions of wines and the regions they come from are also options for this feature.

(3) A “Nutritional Information” icon (e.g., 134, FIG. 11) will show nutritional information about a particular food item. This feature fits the latest trends in the restaurant industry, which relates to the growing health concern about eating habits (i.e., use of low-carbohydrate, low-cholesterol, low-fat, or vegetarian food for restricted diets).

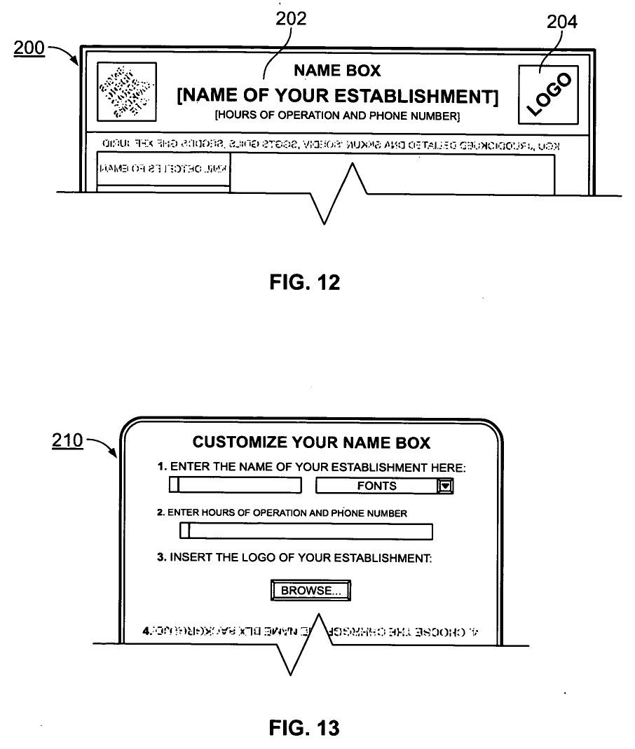

An establishment can easily update information on an electronic menu board. Typically, a CD-ROM or other media containing an upload program (sometimes called a “wizard” in the United States) will be used to update the menu board. FIG. 12 from an upload program shows a representation of a menu board display 200 having an area 202 for the name and associated information for an establishment, and an area 204 for display of a logo of the establishment. FIG. 13 shows a dialog box 210 from such an upload program in which the establishment is asked to input the information (e.g., name of establishment, logo) that will appear in areas 202 and 204 in FIG. 12. Updating information can, therefore, be accomplished very easily and quickly by the establishment

While the invention has been described with respect to specific embodiments by way of illustration, many modifications and changes will occur to those skilled in the art. It is, therefore, to be understood that the appended claims are intended to cover all such modifications and changes as fall within the true scope and spirit of the invention.

What is claimed is:

1. A method of rapidly informing a passerby outside a food-and-beverage establishment about the establishment, so as to entice the passerby to use the services of the food-and-beverage establishment, comprising:
a) placing an interactive electronic menu board in a location accessible by a passerby from outside the food-and-beverage establishment, the interactive menu board showing, by graphical and textual content, different aspects of the food-and-beverage establishment, and having user-activated links that enable the passerby to expand on a desired category of information about the aspects, and thereby rapidly informing the passerby about the food-and-beverage establishment;
b) the menu board screen providing a passerby with an information-gathering but non-purchasing relationship with the food-and-beverage establishment so that the passerby can become informed about the food-and-beverage establishment in a non-committal manner; and
c) the primary purpose of the menu board being to promote the services of a single establishment.

2. The method of claim 1, further comprising attracting the attention of a passerby in a default mode of operation of the menu board by dynamically broadcasting text or graphics on the menu board or audio sounds in the vicinity of the menu board.

3. The method of claim 1, wherein the interactive menu board is a touch-screen.

4. The method of claim 1, wherein the interactive menu board is mounted on a pedestal or on a wall.

5. The method of claim 1, wherein the interactive menu board is located in the immediate outside vicinity of a food-and-beverage establishment.

6. The method of claim 1, wherein the interactive menu board is framed by structure having the appearance of a menu board for hardcopy menus.

7. The method of claim 1, wherein the interactive menu board includes at least one shortcut icon allowing quick access to categorized information of the food-and-beverage establishment.

8. The method of claim 7, wherein the at least one shortcut icon is always present on the menu board.

9. The method of claim 1, wherein attracting the attention of a passerby in a default mode of operation comprises providing a default, dynamic display of images on the interactive menu board showing some aspects of the food-and-beverage establishment.

10. The method of claim 9, wherein the majority of the default, dynamic display of images concerns a single establishment.

11. The method of claim 9, further comprising providing multi-lingual text accompanying and describing individual images.

12. The method of claim 1, further comprising providing default audio sounds, to capture the attention of a passerby.

13. The method of claim 12, wherein the audio sounds include a language other than a default language of the menu board.

14. The method of claim 1, wherein the interactive menu board provides information about food/beverage and non-food/beverage categories of aspects of the food-and-beverage establishment, so as to reduce the need for the food-and-beverage establishment to additionally display information in hardcopy form of such non-food/beverage categories.

15. The method of claim 1, wherein the menu board provides enhanced, interactively obtained information of at least a menu of the establishment.

16. The method of claim 1, wherein the menu board includes a plurality of icons for selecting different languages for the text displayed on the menu board.

17. The method of claim 1, wherein the informational content of the menu board is easy to update by the establishment.

18. A method of rapidly informing a passerby outside a food-and-beverage establishment about the establishment, so as to entice the passerby to use the services of the food-and-beverage establishment, comprising:
a) placing an interactive electronic menu board in a location accessible by a passerby from outside the food-and-beverage establishment, the interactive menu board showing, by graphical and textual content, different aspects of the food-and-beverage establishment, and having user-activated links that enable the passerby to expand on a desired category of information about the aspects, and thereby rapidly informing the passerby about the food-and-beverage establishment;
b) the menu board screen providing a passerby with an information-gathering but non-purchasing relationship with the food-and-beverage establishment so that the passerby can become informed about the food-and-beverage establishment in a non-committal manner;
c) the primary purpose of the menu board being to promote the services of a single establishment; and
d) the interactive menu board having a view simultaneously showing multiple items in a category of the services of the establishment.

19. The method of claim 18, wherein the items in the category of the establishment comprise foods items served during a particular time period of the day.

20. The method of claim 19, wherein the interactive menu board simultaneously shows most of the food items served during a particular time period of the day.

21. The method of claim 20, wherein each food item comprises a hyperlink, the selection of which gives a potential customer expanded information about the food or beverage item.

22. The method of claim 20, wherein the interactive menu board simultaneously shows all of the food items served during a particular time period of the day.

23. The method of claim 22, wherein each food item comprises a hyperlink, the selection of which gives a potential customer expanded information about the food or beverage item.

24. The method of claim 21, wherein the expanded information includes one or more of the group consisting of an expanded image of the food or beverage item, detailed text description, nutritional information and a preparation video.

25. The method of claim 18, further comprising attracting the attention of a passerby in a default mode of operation of the menu board by dynamically broadcasting text or graphics on the menu board or audio sounds in the vicinity of the menu board.

26. The method of claim 18, wherein the menu board includes at least one shortcut icon allowing quick access to categorized information of the food-and-beverage establishment.

27. The method of claim 26, wherein the at least one shortcut icon is always present on the menu board.

28. The method of claim 18, wherein attracting the attention of a passerby in a default mode of operation comprises providing a default, dynamic display of images on the interactive menu board showing some aspects of the food-and-beverage establishment.

29. The method of claim 28, further comprising providing multi-lingual text accompanying and describing individual images.

30. A method of rapidly informing a passerby outside a food-and-beverage establishment about the establishment, so as to entice the passerby to use the services of the food-and-beverage establishment, comprising:
a) placing an interactive electronic menu board in a location accessible by a passerby from outside the food-and-beverage establishment, the interactive menu board showing, by graphical and textual content, different aspects of the food-and-beverage establishment, and having user-activated links that enable the passerby to expand on a desired category of information about the aspects, and thereby rapidly informing the passerby about the food-and-beverage establishment;
b) the menu board screen providing a passerby with an information-gathering but non-purchasing relationship with the food-and-beverage establishment so that the passerby can become informed about the food-and-beverage establishment in a non-committal manner;
c) the primary purpose of the menu board being to promote the services of a single establishment; and
d) dynamically broadcasting in a default mode, text or graphics on the menu board or sounds near the menu board, informing passersby of the capability of the menu board using a language that differs from a default language.

31. The method of claim 30, wherein dynamically broadcasting comprises a pop-up indication of capability of using a language that differs from a default language.

32. The method of claim 30, wherein the menu board includes a plurality of icons for selecting different languages for the text displayed on the menu board.

33. The method of claim 30, wherein the menu board includes at least one shortcut icon allowing quick access to categorized information of the food-and-beverage establishment.

34. The method of claim 33, wherein the at least one shortcut icon is always present on the menu board.
